(19) United States
(12) Patent Application Publication
(10) Pub. No.: US 2006/0262072 A1
(43) Pub. Date: Nov. 23, 2006

(54) Coordinate input device and terminal device having the same

(75) Inventors: Takahiro Murakami, Fukushima-ken (JP); Hiroshi Shigetaka, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/436,371

(22) Filed: May 17, 2006

(30) Foreign Application Priority Data
May 23, 2005 (JP) 2005-149090

(51) Int. Cl. G09G 3/36

(52) U.S. Cl. 345/100

(57) ABSTRACT

A coordinate input unit is composed of a sensor as a means for detecting a manipulating state on a manipulation surface A manipulated by a coordinate indicator and a front light as an illumination means disposed on the sensor to illuminate the manipulation surface A. When the manipulation surface of the coordinate input device is illuminated, the light emitted from an LED is transmitted in a light introduction plate, emerged from a prism surface, changes its direction by being reflected on a reflection plate, and is directed to the manipulation surface. With this operation, the manipulation surface is illuminated.

### FIELD

A coordinate input device and a terminal device having the same is provided, and more particularly, to a coordinate input device with a light emitting function having the same.

### DESCRIPTION OF THE RELATED ART

Typically, a coordinate input device called a touch pad is mounted on a mobile type computer terminal device such as a notebook personal computer or the like. The touch pad has a pointing device for manipulating a cursor and a pointer displayed on the screen of the terminal device likewise has a mouse or the like. When a user's finger or a tip of a pen comes into contact with a manipulation surface, the contact point thereof is detected by a sensor, and the cursor and the pointer are manipulated in response to the coordinate value of the contact point or the change of the coordinate value resulting from the movement of the contact point.

In the coordinate input device as described above, a device in which a sensor is composed of a sheet having a light transmitting property and a color LCD panel with a back light is disposed under the sensor to illuminate a manipulation surface (refer to Japanese Unexamined Patent Application Publication No. 2003-99187).

However, in the coordinate input device described above, since the LCD panel with the back light is disposed under the sensor, the light from the back light is emitted to the outside through the color LCD and the sensor. Accordingly, since the light from the back light is absorbed by the LCD and the sensor, a problem arises in that a sufficient amount of light cannot be obtained. Further, since the sensor must be composed of a material having the light transmitting property, a problem arises also in cost.

### SUMMARY

A coordinate input device has a manipulation surface manipulated by a coordinate indicator and is characterized by including a mode switch that switches a manipulation mode on the manipulation surface, a control that operates a manipulation in the manipulation mode on the manipulation surface, and an illumination means disposed on the manipulation surface that illuminates the manipulation surface.

Since the illumination means is disposed on the detection means and any other member is not disposed on the illumination means, the light from the illumination means can be effectively used to illuminate the manipulation surface. Accordingly, the coordinate input device can more effectively illuminate the manipulation surface. Further, according to the arrangement, since the manipulation in the manipulation mode can be operated on the manipulation surface, manipulations in many manipulation modes can be executed on the manipulation surface, thereby usability can be enhanced.

In the coordinate input device, it is preferable that the illumination means include a light source and a light introduction means having a prism surface on the detection means side for directing the light from the light source to the manipulation surface. In this case, it is preferable that a display corresponding to the manipulation mode be formed on the manipulation surface.

According to the arrangement, since a user can execute a manipulation in a manipulation mode according to a display for manipulation illuminated on the manipulation surface, the user can simply execute the manipulation in the manipulation mode.

A terminal device which is provided with the coordinate input device and characterized by including a light source control means for controlling the light source based on the function of the terminal device or the detection means is provided. In the terminal device, it is preferable that the light source control means exert a display effect in association with a manipulation in the manipulation mode.

According to these arrangements, it is possible to exert a display effect for illuminating the manipulation surface based on the function of the terminal device or the detection means. With this operation, it is possible for the user to visually recognize the function of the terminal device or the detection means as well as a decorative effect can be also exerted.

The coordinate input device having a manipulation surface manipulated by a coordinate indicator includes a mode switching means for switching a manipulation mode on the manipulation surface, a control means for operating a manipulation in the manipulation mode on the manipulation surface, and an illumination means disposed on the manipulation surface for illuminating the manipulation surface. Accordingly, the light from the illumination means can be effectively used to illuminate the manipulation surface with a result that the manipulation surface can be effectively illuminated. Further, since the manipulation in the manipulation mode can be operated on the manipulation surface, manipulations in many manipulation modes can be executed on the manipulation surface, thereby usability can be enhanced.

### BRIEF DESCRIPTION OF THE DRAWINGS

FIG. 1 is a view showing a schematic arrangement of a terminal device having a coordinate input device;

FIG. 2 is a view showing an internal arrangement of a PC main body in the terminal device shown in FIG. 1;

FIG. 3 is a view showing an internal arrangement of a controller in the terminal device shown in FIG. 1;

FIG. 4 is a view showing an internal arrangement of a sensor in the terminal device shown in FIG. 1;

FIG. 5 is a view showing a display shown on a manipulation surface shown in FIG. 1;

FIG. 6 is a view showing a display shown on the manipulation surface shown in FIG. 1; and

FIG. 7 is a view showing a display for manipulation shown on the manipulation surface shown in FIG. 1.

### DESCRIPTION OF THE PREFERRED EMBODIMENTS

An embodiment will be described below in detail with reference to the accompanying drawings.

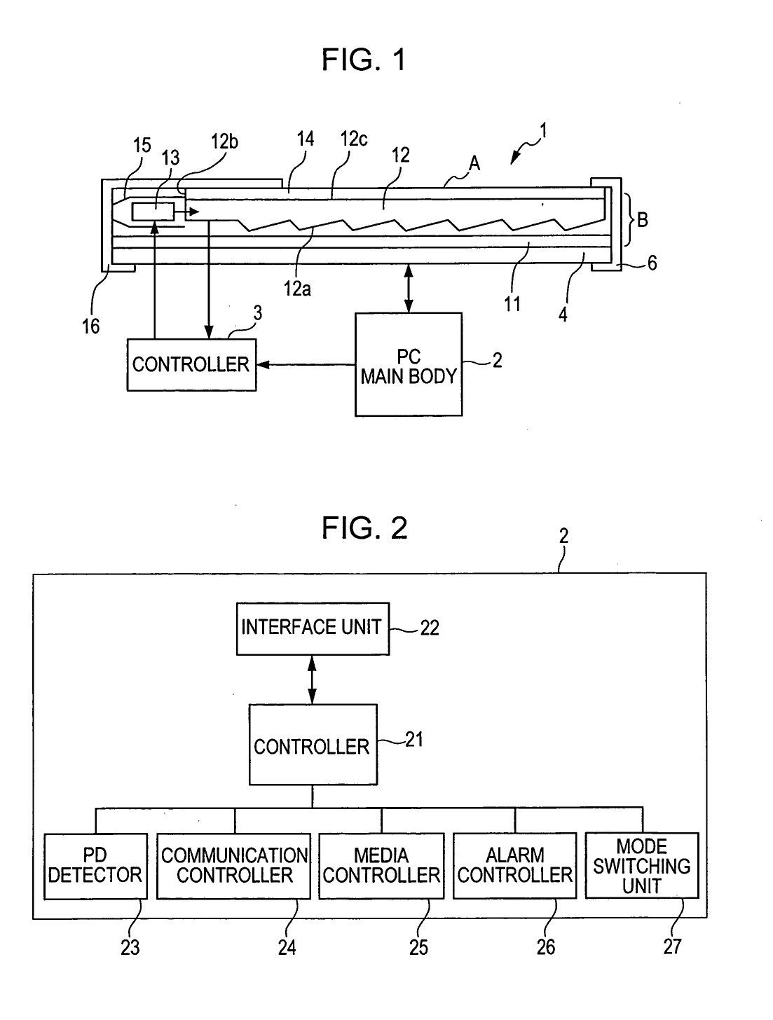

FIG. 1 is a view showing a schematic arrangement of a terminal device having a coordinate input device.

The terminal device shown in FIG. 1 is mainly composed of a coordinate input device 1 having a manipulation surface, which is manipulated by a coordinate indicator such as a user's finger of the like, and can illuminate the manipulation surface by a light source, a personal computer (PC) main body 2, which is electrically connected to the coordinate input device 1 and on which pointing is executed in response to an input executed through the coordinate input device 1, and a controller for controlling the light source of the coordinate input device based on the functions of the coordinate input device 1 and the PC main body 2. The coordinate input device 1 is mounted on the PC main body 2 by being buried therein.

The coordinate input unit 1 is composed of a sensor 4 as a detection means for detecting a manipulating state on the manipulation surface A manipulated by the coordinate indicator, and a front light B as an illumination means disposed on the sensor 4 for illuminating the manipulation surface A. The front light B is composed of a light introduction plate 12, which is formed in a flat plate shape and has a prism surface 12a on the sensor 4 side, an LED 13 as a light source disposed in the vicinity of an edge surface 12b of the light introduction plate 12, and a light diffusion plate 14 disposed on a flat surface 12c opposite to the prism surface 12a of the light introduction plate 12. The light diffusion plate 14 is subjected to crimp processing and the like to enhance the manipulation property thereof because the user's finger as the coordinate indicator is in direct contact therewith. The crimp processing applied to the surface the light diffusion plate 14 can also prevent reflection of external light, in addition to the enhancement of the manipulation property.

A reflection plate 11 is interposed between the sensor 4 and the prism surface 12a of the light introduction plate 12. The LED 13 is covered with a case 15. Further, the sensor 4 and the front light B are integrated with each other by being fixed to a fixing frame 16 at both the edges thereof.

Further, the sensor 4 of the coordinate input device 1 is electrically connected to the PC main body 2 and the interior material, respectively. Further, the controller 3 is electrically connected to the LED 13 so that it variously controls the LED 13.

A user can move a cursor (or pointer) on the screen of the PC main body 2 by placing a finger in the region (manipulation surface) of the light diffusion plate 14 corresponding to the sensor 4 of the coordinate input device 1 having the arrangement as described above and sliding the finger in this state. Further, various manipulations such as selection, movement, and the like of a body displayed on the screen by tapping the manipulation surface A with a finger likewise when a left button of a mouse is clicked. A manipulation such as start of an application and the like can be realized by tapping the manipulation surface twice or likewise when the mouse is clicked twice. Further, the body on the screen can be moved up to a desired position by placing the cursor on the body and moving the cursor (slide manipulation, drag manipulation) after tapping is executed. Further, a scroll bar region is provided on the manipulation surface A, and the screen can be scrolled by sliding a finger on the scroll bar region (scroll manipulation).

When the manipulation surface A of the coordinate input device 1 is illuminated, the light emitted from the LED 13 is transmitted in the light introduction plate 12, emerged from the prism surface 12a, and directed to the manipulation surface A. With this operation, the manipulation surface A is illuminated. Note that the bottom angle of the prism disposed on the prism surface 12a of the light introduction plate 12 is not particularly limited as long as it can direct the light from the LED 13 to the manipulation surface A as described above.

Since the coordinate input device 1 is provided with the front light B, that is, since the illumination means is disposed on the sensor 4 and any other member is not disposed on the illumination means, the light from the illumination means can be effectively used to illuminate the manipulation surface A. Further, since the sensor 4 is disposed under the illumination means, the sensor 4 need not be composed of a transparent material, which is advantageous in cost. As described above, the coordinate input device according to the embodiment can effectively illuminate the manipulation surface A by controlling the LED 13 based on the function of the PC main body 2 or the sensor 4.

Next, internal arrangements of the respective components of the terminal device shown in FIG. 1 will be explained. FIG. 2 is a view showing an internal arrangement of the PC main body in the terminal device shown in FIG. 1. The PC main body 2 shown in FIG. 2 includes a controller 21 for controlling the device in its entirety, an interface unit 22 as a communication port for executing a communication between the respective components, a PD detector 23 for detecting whether or not a pointing device (PD) such as a mouse or the like is attached to the PC main body 2, a communication controller 24 for controlling a network computing system, an electronic mail, and the like, a media controller 25 for controlling manipulation of various media (CD, DVD, and the like) in which audio, video, and the like are stored, an alarm controller 26 for controlling various alarms in the PC main body 2, and a mode switching unit 27 for switching a mode when the coordinate input device is used by a manipulation other than the manipulation executed using the cursor. Note that since the PC main body 2 includes the functions of an ordinary computer, it has all the processing units provided with the ordinary computer, in addition to the above processing units.

The PD detector 23 detects when the PD is connected to the PC main body 2 and can be manipulated in cooperation with the PC main body 2. The communication controller 24 mainly realizes a browser function and a mail function by controlling connection to a network such as the Internet and the like. The media controller 25 controls media, for example, replays and stops CDs and DVDs in the PC main body 2 in a mode for manipulating media in response to an input from the coordinate input device 1. The alarm controller 26 generates some kind of alarm when the PC main body 2 fails or is in an abnormal state and when it is necessary to warn the user or to make a report to the user. The mode switching unit 27 switches a mode when the coordinate input device 1 is used to an application other than the application as the pointing device (a manipulation other than the manipulation of the cursor, for example, a manipulation of media, input of characters, and the like).

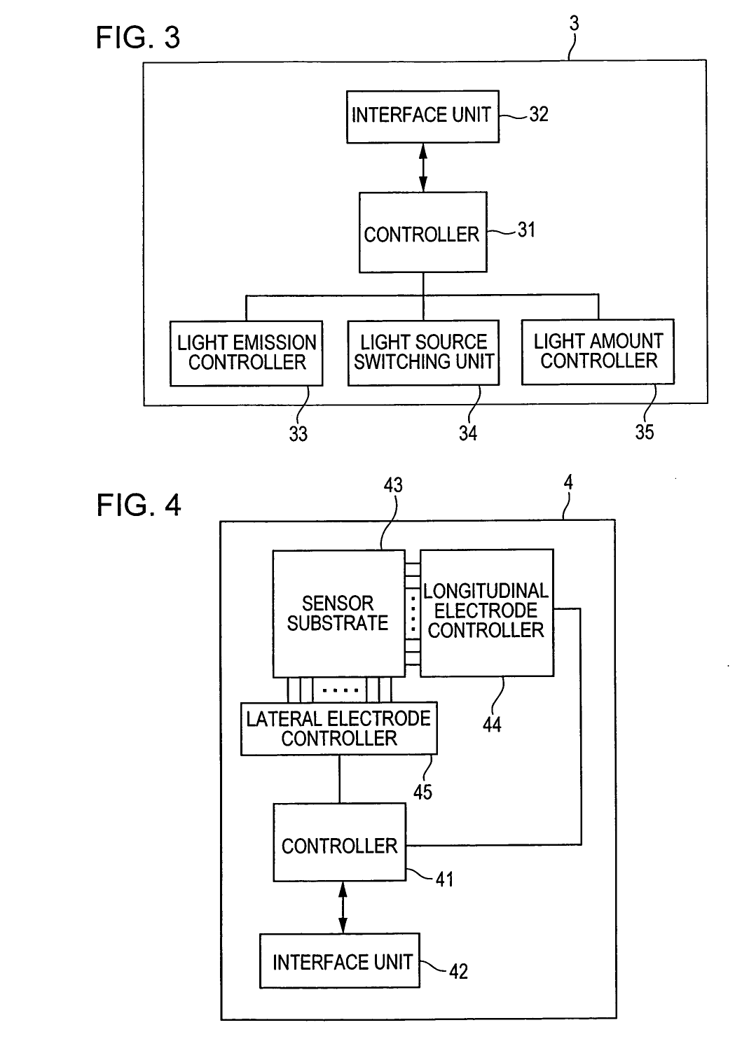

FIG. 3 is a view showing an internal arrangement of the controller in the terminal device shown in FIG. 1. The controller 3 shown in FIG. 3 includes a controller 31 for controlling the device in its entirety, an interface unit 32 as a communication port for executing a communication between the respective components, a light emission controller 33 for controlling ON/OFF and blinking of emitted light, a light source switching unit 34 for switching a plurality of LEDs 13, and a light amount controller 35 for changing brightness of the LED 13. Note that although the LED 13 is controlled by the controller 3 in the embodiment, the LED 13 may be directly controlled by the PC main body 2 or may be controlled by the PC main body 2, a controller other than the controller 3, and an IC.

The light emission controller 33, the light source switching unit 34, and the light amount controller 35 are control means for controlling the LED 13 as the light source based on the function of the PC main body 2 or the sensor 4. The light emission controller 33 puts the LED 13 ON and OFF or blinks it by turning ON and OFF it according to the function of the PC main body 2 or the sensor 4. When the plurality of LEDs 13 are used and emitted according to the function of the PC main body 2 or the sensor 4, in particular, when LEDs having a plurality of colors are used and emitted, the light source switching unit 34 switches the LEDs. The light amount controller 35 changes the brightness of the LED 13 according to the function of the PC main body 2 or the sensor 4. Note that the light emission controller 33, the light source switching unit 34, and the light amount controller 35 may independently control the LED. Otherwise, they may be arranged as a light controller for controlling all of light emission, switching of light sources, and adjustment of light amount.

FIG. 4 is a view showing an internal arrangement of the sensor in the terminal device shown in FIG. 1. The sensor 4 shown in FIG. 4 includes a controller 41 for controlling the device in its entirety, an interface unit 42 as a communication port for executing a communication between the respective components, a sensor substrate 43, a longitudinal electrode controller 44 for controlling longitudinal electrodes connected to the sensor substrate 43, and a lateral electrode controller 45 for controlling lateral electrodes connected to the sensor substrate 43.

The sensor substrate 43 shown in FIG. 4 has a plurality of the longitudinal electrodes and a plurality of the lateral electrodes disposed on the front surface or the back surface of a film, respectively. The longitudinal electrodes and the lateral electrodes are disposed in a matrix shape. When the user's finger comes into contact with the manipulation surface A of the coordinate input device 1 having the sensor substrate 43 arranged as described above, the capacitance of the contact portion of the sensor substrate 43 decreases. The amounts of change of the respective electrodes are detected by converting the change of the capacitance into the change of current values. The positions of the finger in a longitudinal direction and a lateral direction are detected, respectively by the amounts of change of the respective electrodes. Note that although a case in which the sensor substrate 43 is arranged as a capacitance type is described here, the sensor substrate 43 may be arranged as other type, for example, a pressure sensitive type.

The longitudinal electrode controller 44 is a circuit for scanning the sensor substrate 43 in the longitudinal direction and generates a serial detection signal showing a scanning state of the user's finger. The serial detection signal includes a tap component generated when the finger is tapped on the manipulation surface A of the sensor substrate 43 and a slide component generated when the finger is slid on the manipulation surface A. The lateral electrode controller 45 is a circuit for scanning the sensor substrate 43 in the lateral direction. A tap component here includes an address component showing the position where the finger is in contact with the manipulation surface A, and the slide component includes an address component showing from which position to which position the finger slides.

Next, various applications for emitting the manipulation surface A in the terminal device arranged as described above will be explained.

(1) The manipulation surface A is controlled such that it is illuminated when the PC main body 2 receives a piece of mail.

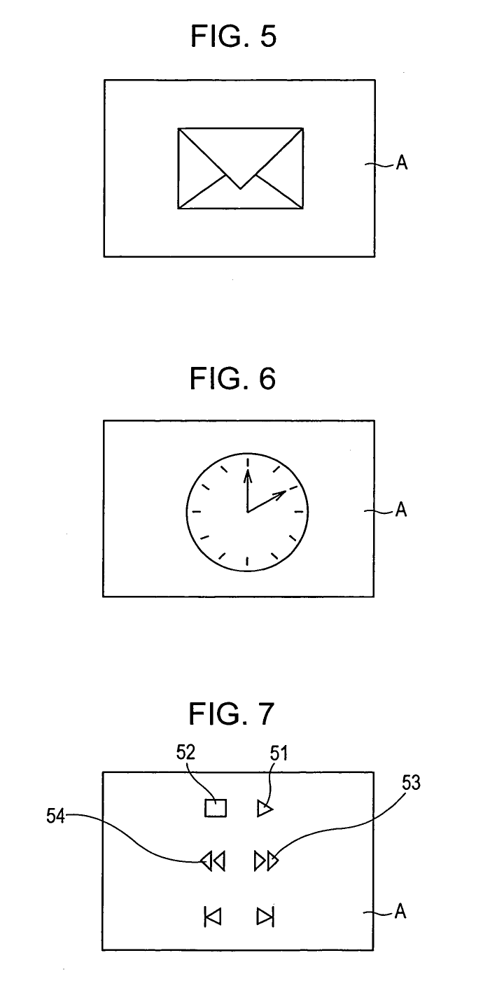

When the PC main body 2 receives the mail, the communication controller 24 of the PC main body 2 issues a control signal indicating that the mail has been received, and the control signal is supplied to the light emission controller 33 through the interface unit 22 of the PC main body 2 and the interface unit 32 of the controller 3. The light emission controller 33 turns ON the LED in response to the control signal. With this operation, it is possible to illuminate (to turn on or to blink) the manipulation surface A when the PC main body 2 receives the mail. Further, when an icon (for example, an icon of envelope) as shown in FIG. 5 is formed on the light diffusion plate 14 of the coordinate input device 1 or on the flat surface 12c of the light introduction plate 12 thereof, the icon is illuminated on the manipulation surface A at the time the manipulation surface A is illuminated. With this arrangement, the user can visually recognize that the mail is received from the display illuminated on the manipulation surface A.

(2) The manipulation surface A is controlled such that it is illuminated when a time, at which a schedule is set in the PC main body 2, arrives.

When a set time arrives in a scheduler of the PC main body 2, a control signal indicating that the set time has arrived is output from the scheduler of the PC main body 2 to the alarm controller 26, and a control signal indicating that an alarm is issued is supplied from the alarm controller 26 to the light emission controller 33 through the interface unit 22 of the PC main body 2 and though the interface unit 32 of the controller 3. The light emission controller 33 turns ON the LED in response to the control signal. With this operation, it is possible to illuminate (to turn on or to blink) the manipulation surface A when the set time arrives in the PC main body 2. Further, when an icon (for example, an icon of clock) as shown in FIG. 6 is formed on the light diffusion plate 14 of the coordinate input device 1 or on the flat surface 12c of the light introduction plate 12 thereof, the icon is illuminated on the manipulation surface A at the time the manipulation surface A is illuminated. With this arrangement, the user can visually recognize that the set time arrives from the display illuminated on the manipulation surface A.

(3) When the PC main body 2 is set to a media manipulation mode, a media control manipulation is executed on the manipulation surface A of the coordinate input device 1.

When the user controls media in the media manipulation mode, a control signal indicating that media are controlled is output from the mode switching unit 27 of the PC main body 2 and supplied to the light emission controller 33 through the interface unit 22 of the PC main body 2 and though the interface unit 32 of the controller 3. The light emission controller 33 turns ON the LED in response to the control signal. With this operation, an icon (display for manipulation) as shown in FIG. 7 is displayed on the manipulation surface A of the coordinate input device 1. Further, the control signal is supplied also to the media controller 25.

The media controller 25 executes a control such that a manipulation can be executed according to the icon displayed on the manipulation surface A. That is, when a predetermined display portion for manipulation is depressed, the capacitance of the contact portion of the sensor substrate 43 of the sensor 4 decreases. The amounts of change of the respective electrodes are detected by converting the change of the capacitance into the change of current values. The positions of the finger in the longitudinal direction and the lateral direction are detected, respectively by the amounts of change of the respective electrodes. The position information detected as described above is supplied to the media controller 25 through the interface unit 42 and through the interface unit 22 of the PC main body 2.

The media controller 25 controls media based on the position information in the sensor substrate 43, that is, based on the information indicating which display for manipulation is depressed. Note that a correspondence relation between the icons displayed for manipulation and the media manipulated by the icons is predetermined, and the information of the correspondence relation is stored in the media controller 25 or in the controller 21 in a form of a table and the like. Accordingly, the media controller 25 fixes a medium to be manipulated with reference to the information of the correspondence relation based on the position information from the sensor 4 and executes a control so that the medium is manipulated. Specifically, when a replay display portion 51 shown in FIG. 7 is depressed, the media controller 25 executes a replay control, when a stop display portion 52 is depressed, the media controller 25 executes a stop control, when a fast-forward display portion 53 is depressed, the media controller 25 executes a fast-forward control, and when a rewind display portion 54 is depressed, the media controller 25 executes a rewind control.

The icon (for example, icon for manipulation) as shown in FIG. 7 is preferably formed on the light diffusion plate 14 and on the prism surface 12a of the light introduction plate 12 of the coordinate input device 1. With this arrangement, when the manipulation surface A is illuminated, the icon is illuminated on the manipulation surface A. Thus, since the user can execute a manipulation in a manipulation mode according to the icon illuminated on the manipulation surface A, the user can simply execute the manipulation in the manipulation mode.

Further, when the user switches a mode to the manipulation mode, it may be automatically switched when a mouse is connected. That is, when the PD is connected to the PC main body 2, the PD detector 23 detects that the PD is connected and outputs a control signal indicating that the PD is connected. The control signal is supplied to the light emission controller 33 through the interface unit 22 of the PC main body 2 and through the interface portion 32 of the controller 3. The light emission controller 33 turns ON the LED in response to the control signal. Further, the control signal is supplied also to the media controller 25. The media controller 25 executes a control such that a manipulation can be executed according to the icon displayed on the manipulation surface A.

Note that in the media control, a display effect may be exerted on the manipulation surface A by controlling the light source in association with the media manipulation control. For example, when a medium is replayed, the light source may be blinked or lit in a different color on the manipulation surface A in association with music. With this operation, a decorative effect can be exerted on the manipulation surface A. In this case, various display effects are arranged using the light emission controller 33, the light source switching unit 34, and the light amount controller 35 of the controller 3. When the display effects are exerted, patterns of timings, at which light is emitted, the light source is switched, and an amount of light is changed, are previously set, and the timings are controlled according to the patterns.

As described above, in the embodiment, since any other component is not disposed on the front light of the coordinate input device 1, the light from the front light can be effectively used to illuminate the manipulation surface A, thereby the manipulation surface A can be effectively illuminated. Since the manipulation in the manipulation mode can be operated on the manipulation surface A, manipulations in many manipulation modes can be executed on the manipulation surface A, thereby usability can be enhanced. Further, in the terminal device of the embodiment, it is possible to exert a display effect of illuminating the manipulation surface A based on the function of the PC main body 2 or the sensor 4. With this operation, the function of the PC main body 2 or the sensor 4 can be visually recognized as well as the decorative effect can be also exerted. Note that the function of the PC main body 2 or the sensor 4 is not limited to the one described above. The manipulation surface A is illuminated in association with a function that can be executed by the PC main body 2 or the sensor 4.

The present invention is by no means limited to the above embodiment and can be embodied in variously modified states. For example, in the embodiment, the optical components such as the light introduction plate, the reflection plate, and the light diffusion plate are not limited to the plate-shaped member and may be embodied by being appropriately modified to a film-shaped member, a sheet-shaped member, and the like. The embodiment describes a case that the light source is composed of the LED, the light source in the present invention may be composed of a light source other than the LED.

Further, the embodiment describes a case in which the icon is formed on the flat surface of the light diffusion plate and the light introduction plate of the coordinate input device. In the present invention, however, the icon may be formed in any portion of the coordinate input device and the front light as long as the icon is illuminated when the coordinate input device is illuminated. In addition to the above-mentioned, the coordinate input device may be embodied by being appropriately modified as long as it does not deviate from the range of the object of the present invention.

What is claimed is:

1. A coordinate input device comprising a manipulation surface that is manipulated by a coordinate indicator, wherein the coordinate input device includes a mode switch that switches a manipulation mode on the manipulation surface, a control that operates a manipulation in the manipulation mode on the manipulation surface, and illumination means disposed on the manipulation surface that illuminates the manipulation surface.

2. A coordinate input device according to claim 1, wherein the illumination means comprises a light source and light introduction means having a prism surface on a detection means side that directs the light from the light source to the manipulation surface.

3. A coordinate input device according to claim 2, wherein a display corresponding to the manipulation mode is formed on the manipulation surface.

4. A terminal device includes a coordinate input device having a manipulation surface manipulated by a coordinate indicator, wherein the coordinate input device comprises:
mode switching means that switches a manipulation mode on the manipulation surface;
control means that operates a manipulation in the manipulation mode on the manipulation surface;
illumination means disposed on the manipulation surface that illuminates the manipulation surface, the illumination means comprising a light source and light introduction means having a prism surface on the detection means side that directs the light from the light source to the manipulation surface; and
light source control means that controls the light source based on the function of the terminal device or the detection means.

5. A coordinate input device according to claim 4, wherein a display corresponding to the manipulation mode is formed on the manipulation surface the coordinate input device.

6. A terminal device according to claim 4, wherein the light source control means exerts a display effect in association with a manipulation in the manipulation mode.

7. A terminal device according to claim 5, wherein the light source control means exerts a display effect in association with a manipulation in the manipulation mode.

8. A coordinate input device, characterized by comprising:
a coordinate input member comprising a manipulation surface manipulated by a coordinate indicator, a detection sensor that detects a manipulating state of the coordinate indicator on the manipulation surface, and illumination means that illuminates the manipulation surface;
a computer main body on which pointing is executed by the coordinate input member; and
a controller that controls a light source of the illumination means based on the functions of the coordinate input means and the computer main body,
wherein the illumination means is interposed between the manipulation surface and the detection sensor and illuminates the manipulation surface in its entirety by introducing the light from the light source.

9. A coordinate input device according to claim 8, wherein the illumination means includes an icon sheet on the lower surface of the manipulation surface, and the icon is illuminated by illuminating the manipulation surface by the illumination means.

10. A coordinate input device according to claim 8, wherein the controller comprises at least one of a light emission controller, a light source switching unit, and a light amount controller of the light source.
